(19) United States
(12) Patent Application Publication
(10) Pub. No.: US 2023/0380351 A1
(43) Pub. Date: Nov. 30, 2023

(54) OPEN-SOURCE SYSTEM FOR PROVIDING ENVIRONMENTAL DATA

(71) Applicant: AI Grow LLC, Stillwater, MN (US)

(72) Inventor: Christopher M. Ellis, Stillwater, MN (US)

(21) Appl. No.: 18/142,955

(22) Filed: May 3, 2023

Related U.S. Application Data
(60) Provisional application No. 63/364,125, filed on May 4, 2022.

(51) Int. Cl. A01G 9/24; F24F 11/63; A01G 9/18

(52) U.S. Cl. CPC A01G 9/246; F24F 11/63; A01G 9/18; A01G 9/247; F24F 2110/10

(57) ABSTRACT

The disclosure is related to an open-source environmental apparatus, system, and method of use. The apparatus may include a sensor module with one or more of temperature, humidity, carbon dioxide sensors for detecting environmental conditions. The apparatus may also include a light sensor for detecting light levels. A processor is used to gather the information and organize the data in an open-source accessible format and communicate it via a communication module. The sensors, processor, and communication module are housed in an enclosure the openings to allow airflow past the sensors. The system includes the apparatus and an environmental control system that has a computer in communication with the apparatus and several environmental regulation subsystems. The method may include using the apparatus to obtain environmental data and transmit it in an open-source accessible format.

### BACKGROUND OF THE DISCLOSURE

### 1. Field of the Disclosure

The present disclosure relates to sensing systems and, more particularly, to a three-dimensional (3D) printed housing that contains electronic sensors configured to report data on air temperature, carbon dioxide (CO2), relative humidity, and lighting intensity levels for use in environmental control and automation.

### 2. Description of the Related Art

The problem the present disclosure (colloquially known as “The Birdhouse”) solves is the inaccessibility of environmental data in commercial horticulture environments for use in an open-source automation system.

A shortcoming in prior art sensor devices is that they do not report the environmental data in an open-source accessible format for use in full automation systems. Most sensors only record some of the data points and require the use of a proprietary software app that must be licensed through them. These devices do not work well due to their limitations related to data accessibility for use in different automation and data reporting systems. Another shortcoming in prior art sensor devices is that they require translation and integration of multiple devices for computation of vapor-pressure deficit (VPD), which is an important factor in regulating greenhouse and other environment containing live plants.

What is needed is an environmental monitoring suite that provides open-source accessibility that can communicate data in a single format to a processor for environmental regulation.

### BRIEF SUMMARY OF THE DISCLOSURE

In aspects, the present disclosure is related to an apparatus for sensing air temperature, carbon dioxide (CO₂), relative humidity, and lighting intensity levels for use in environmental control and automation, and, in particular, a three-dimensional (3D) printed housing that contains electronic sensors configured to report the aforementioned data.

One embodiment according to the present disclosure includes an apparatus for providing/reporting environmental data, including an enclosure that has a roof; a plurality of walls connected to the roof, wherein the plurality of walls comprises at least: a first wall with a first plurality of openings; a second wall with a second plurality of openings; and a third wall disposed opposite the first wall with a third plurality of openings; and a fourth wall disposed opposite the second wall; where the first plurality of openings is disposed opposite the third plurality of openings to form an air flow path through the interior of the enclosure; and a base connected to the plurality of walls. Also included in the apparatus are a processor disposed on the base inside the enclosure; a communications module disposed on the base inside of the enclosure and in electrical communication with the processor; a sensor module disposed inside the enclosure and in electrical communication with the processor, including a temperature sensor, a humidity sensor, and a carbon dioxide sensor; wherein the processor is configured to organize data received from the temperature sensor, the humidity sensor, and the carbon dioxide sensor in an open-source accessible format and transmit the data to the communications module; and where the temperature sensor, the humidity sensor, and the carbon dioxide sensor are positioned proximate to the air flow path. The roof may include an opening configured to allow light to enter the enclosure, and the apparatus may further include a light sensor positioned proximate to the opening in the roof and in electrical communication with the processor; wherein the processor is configured to organize data from the light sensor in the open-source accessible format. One or more fans may be disposed in or on enclosure and adjacent to at least one of the openings in the first wall. At least one filter may be disposed to cover the openings in the first wall and at least one filter covering the openings in the third wall. A plurality of communications connectors may be disposed in the second plurality of openings. The enclosure is isolated from air in the ambient environment except for the first plurality of openings and the third plurality of openings.

Another embodiment according to the present disclosure is a system for regulating environmental conditions that includes a sensor apparatus, that includes an enclosure made up of at least a roof with an opening configured to allow light to enter the enclosure; a plurality of walls connected to the roof, wherein the plurality of walls comprise at least: a first wall with a first plurality of openings; a second wall with a second plurality of openings; and a third wall disposed opposite the first wall with a third plurality of openings; and a fourth wall disposed opposite the second wall; where the first plurality of openings is disposed opposite the third plurality of openings to form an air flow path through the interior of the enclosure; and a base connected to the plurality of walls. The sensor apparatus also includes a processor disposed on the base inside the enclosure; a communications module disposed on the base inside of the enclosure and in electrical communication with the processor; a sensor module disposed inside the enclosure and in electrical communication with the processor, including a temperature sensor, a humidity sensor, and a carbon dioxide sensor; wherein the processor is configured to organize data received from the temperature sensor, the humidity sensor, and the carbon dioxide sensor in an open-source accessible format and transmit the data to the communications module; and where the temperature sensor, the humidity sensor, and the carbon dioxide sensor are positioned proximate to the air flow path; a computer in data communication with the communications module and configured to receive the data from the temperature sensor, the humidity sensor, and the carbon dioxide sensor in the open-source accessible format; and at least one environmental regulation subsystem in data communication with the computer and configured to respond to a computer instruction to modify an environmental parameter based on the received data. The at least one environmental regulation subsystem may include one or more of: a damper, a heater, a humidifier, a dehumidifier, a circulation fan, an exhaust fan, and an irrigation source. The system may include a transmitter, where the computer is in electrical communication with the transmitter. The roof may include an opening configured to allow light to enter the enclosure, and the sensor apparatus may include a light sensor positioned proximate to the opening in the roof and in electrical communication with the processor; wherein the processor is configured to organize data from the light sensor in the open-source accessible format. The at least one environmental regulation subsystem may include a light source that can be controlled based on the information from the light senor. The sensor apparatus may include one or more fans disposed in enclosure and adjacent to at least one of the openings in the first wall. The sensor apparatus may include at least one filter covering the openings in the first wall and at least one filter covering the openings in the third wall.

Another embodiment of the present disclosure includes a method The method of operating an environmental system, the method including the steps of: receiving environmental data from at least one sensor, where the at least one sensor is selected from: a temperature sensor, a humidity sensor, a carbon dioxide sensor, and a light sensor; converting the environmental data into open-source accessible data; and transmitting the open-source accessible data. The method may also include a step of operating at least one environmental regulatory system based on the open-source accessible data, wherein the at least one environmental regulatory system is one of a damper, a heater, a humidifier, a dehumidifier, a circulation fan, an exhaust fan, and an irrigation source. The method may also involve the at least one sensor including the temperature sensor, the humidity sensor, and the carbon dioxide sensor; and including the step of calculating a vapor pressure deficit using the open-source accessible data.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 is a front perspective view of an enclosure of a first embodiment according to the present disclosure, shown disassembled;

FIG. 2 is a front perspective view of an enclosure of a second embodiment according to the present disclosure, shown partially disassembled;

FIG. 3 is a rear perspective view of the enclosure of the second embodiment according to the present disclosure, shown partially disassembled;

FIG. 4 is a bottom perspective view of the enclosure of the second embodiment according to the present disclosure, shown with the bottom of the enclosure removed;

FIG. 5 is a perspective view of the enclosure of the second embodiment according to the present disclosure, shown with a pole mount coupled to the enclosure;

FIG. 6 is a picture of a perspective view of the second embodiment according to the present disclosure, shown in use;

FIG. 7 is a picture of a perspective view of the second embodiment according to the present disclosure, shown in use;

FIG. 8 is a diagram of a system showing integration of the apparatus of FIG. 6 with environmental control devices according to one embodiment of the present disclosure; and

FIG. 9 is a flow chart of a method for using the system of FIG. 8 according to one embodiment of the present disclosure.

### DETAILED DESCRIPTION OF THE DISCLOSURE

Generally, the present disclosure relates to apparatuses for an environmental sensor suite configured to report environmental data in an open-source accessible format. The present disclosure is susceptible to embodiments of different forms. They are shown in the drawings, and herein will be described in detail, specific embodiments of the present disclosure with the understanding that the present disclosure is to be considered an exemplification of the principles of the present disclosure and is not intended to limit the present disclosure to that illustrated and described herein. The figures may show exaggerated thicknesses of some of the elements so that all the elements are easily viewable.

The following detailed description is of the best currently contemplated modes of carrying out exemplary embodiments of the present invention. The description is not to be taken in a limiting sense but is made merely to illustrate the general principles of the present invention since the scope of the present invention is best defined by the appended claims.

Broadly, an embodiment of the present disclosure provides an open-source system for providing/reporting environmental data.

The present disclosure solves the data accessibility problems discussed above by utilizing open-source programming and sensors to provide the environmental data in an industry-standard format that could be used by any automation system in the world. Any open-source programming language, for example, Python, may be used as would be understood by a person of ordinary skill in the art. The custom and attractive design of the present disclosure allows for all sensors to be combined in an easily mountable enclosure and have the data report back to the automation system. Thus, a single data collection suite can be packaged and used with a single communication protocol and easy data integration since all of the sensors “speak” the same language.

The present disclosure eliminates the requirement of using third-party software to see and use environmental data. By not requiring third-party stand-alone software, the environmental data is accessible and usable by any automation system to automate the environmental control devices and log all data for use in reporting. Now, all of the environmental data can be available to a data control device, such as a Programmable Logic Controller (PLC), and other computer devices, which may use this information to modify or regulate the environment, such as initiating changes in temperature, regulated moisture levels, operating sprinklers or misting devices, air conditioning, louvers, and other environmental devices and systems as would be understood by a person of ordinary skill in the art.

The present disclosure is an improvement over other environmental devices, in part, by providing the full package of required sensors in a single ornamental enclosure. The data is then available for use with any automation system to control lights, blackout curtains, exhaust and/or circulation fans, HVAC (heating, ventilation and air conditioning) systems, humidifiers and/or dehumidifiers, CO2 concentration levels, and the like. Full facility automated control with any automation system is achievable using embodiments of the present disclosure.

Referring now to FIGS. 17, two similar apparatuses are discussed, which share the same sensors but use different enclosure structures. FIG. 1 shows a diagram of an enclosure 101 for an apparatus 100 according to the present disclosure. The enclosure 101 includes a top portion 110 and a bottom portion 112. The top portion 110 includes a roof 111 with an opening 113. The opening 113 may be configured to allow light to enter the enclosure 101 so that light levels can be measured. The opening 113 may be transparent to light but prevent moisture from entering through it, such as a glass or plastic plate. The bottom portion 112 may include a set of lower walls 114, a base 115, and a set of upper walls 116. Different walls within the set of walls may include a plurality of openings 120, 130, 140. The openings 120, 130 may be configured to allow air flow into the enclosure 101. The openings 120 may be disposed opposite the openings 130 so that air flows between the openings 120, 130 through the enclosure 101. The openings 140 may be configured to receive communications wires or cables through one of the lower walls 114. A hinge 150 may be disposed between the one of the lower walls 114 and one of the upper walls 116 and configured to allow the interior of the enclosure 100 exposed when moving from a closed position to an open position.

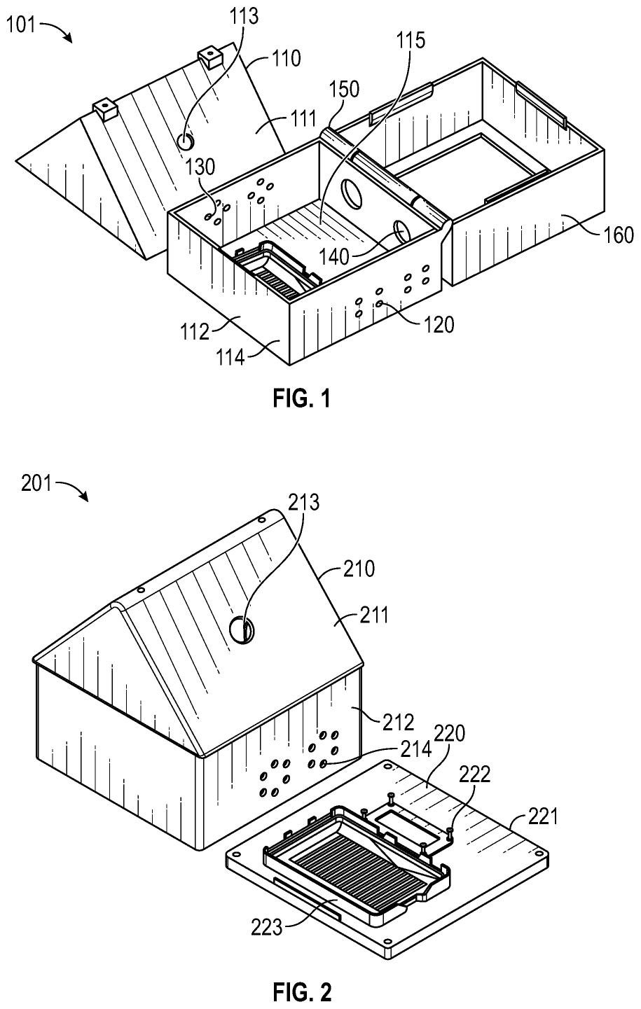

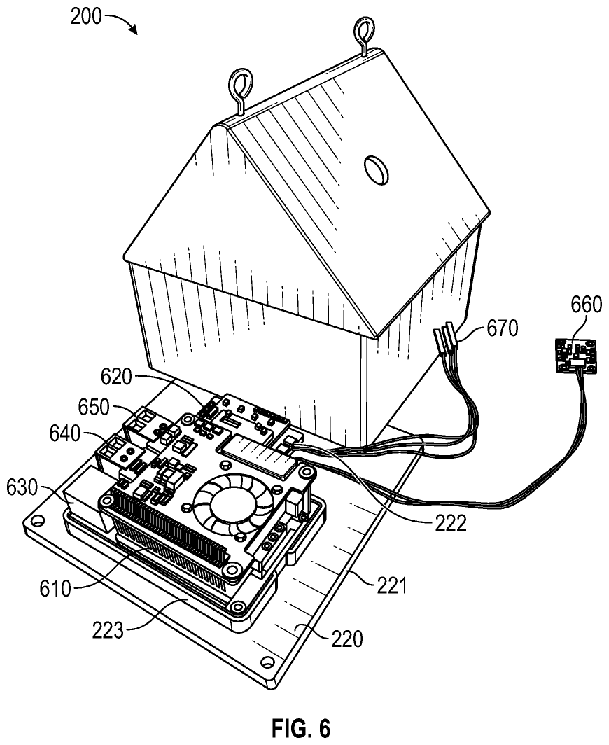

FIG. 2 shows a diagram of an enclosure 201 for an apparatus 200 (see FIG. 6) according to the present disclosure. The enclosure 201 includes a top portion 210 and a bottom portion 220. The top portion 210 includes a roof 211 with an opening 213 and a set of walls 212. The opening 213 may be configured to allow light to enter the enclosure 201 so that light levels can be measured. The opening 213 may be transparent to light but prevent moisture from entering through it, such as a glass or plastic plate. Different walls within the set of walls 212 may include a plurality of openings 214 configured to allow air flow into the enclosure 201. The bottom portion 220 may include a base 221. Disposed on the base 221 may be cradle 222 for holding a sensor module 630 and a cradle 223 for holding a processor 610. A similar set of cradles 222, 223 may be used on the apparatus 100.

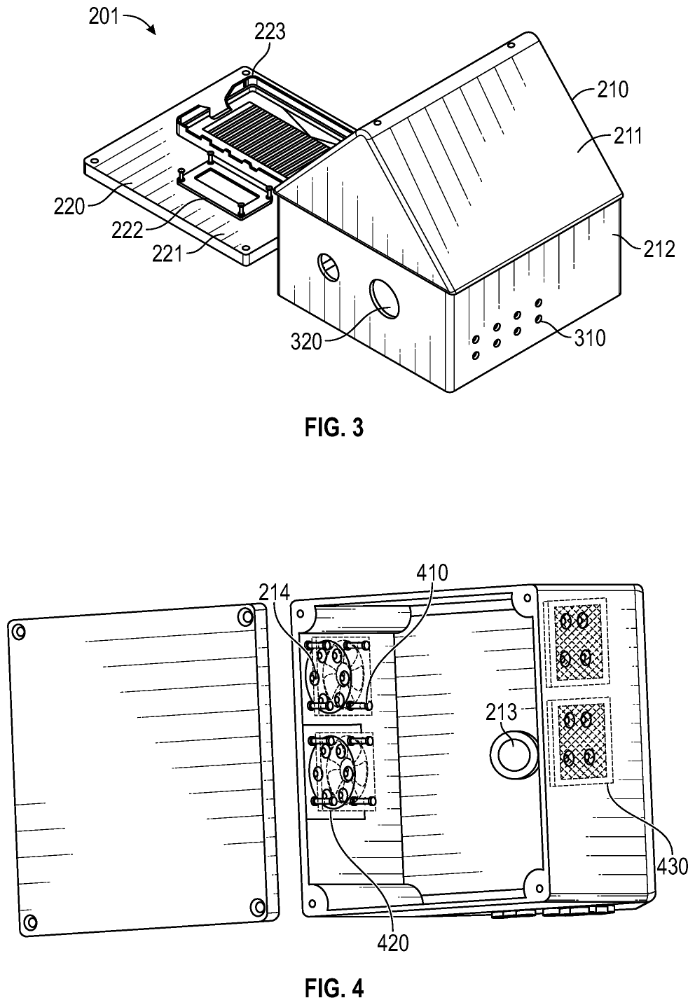

FIG. 3 shows a diagram of the enclosure 201 from another angle to show a plurality of openings 310 configured for air flow through the enclosure 201 and positioned opposite the openings 214. On a wall 212 between the openings 214, 310 are a set of ports 320 configured to receive communications wires or cables, such as Ethernet cables.

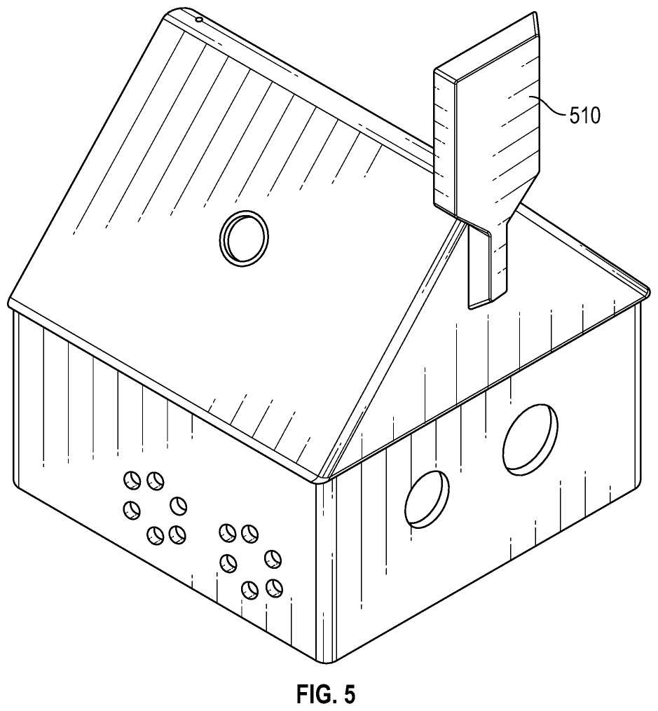

FIG. 4 shows a diagram of the interior of the enclosure 201. Another set of openings 310 may disposed in a one of the walls 212 opposite the openings 214 so that air may flow across the interior of the enclosure 201. Mounting pins 410 or other suitable fasteners may be disposed around the openings 214 so that fans, such as fan 420, may be placed in the enclosure to generate air flow. One or more fans 420 may be installed inside (as shown) or outside of the enclosure 101, 201 adjacent to either the openings 120, 214 or the openings 130, 310. This allows the fans 420 to pull or push air directly across the sensor module 630 and ensures that the most accurate environmental data is being obtained real-time. In some embodiments, the fans 420 may optional. The apparatus 200 may also include air filters 430 disposed adjacent to the openings 214, 310 to keep dust, pollen, and other undesirable airborne materials from entering the enclosure 201 and accumulating on the sensors 620, 660 resulting in inaccurate readings. The air filters 430 may be disposed inside or outside of the enclosure. In some embodiments, where air quality is already contaminant free, the air filters may be optional 430.

FIG. 5 shows a diagram of the apparatus 100, 200 with a pole mounting attachment 510 fastened to the apparatus 100, 200 that it may be secured or positioned within its environment.

FIG. 6 shows a diagram of the apparatus 200 with the top portion 210 separated from the bottom portion 220. The processor 610 is disposed in the cradle 223 and the sensor module 620 is disposed in the cradle 222. A sensor module 620 is disposed next to and in electronic communication the processor 610. The sensor module 620 may include one or more sensors, including a temperature sensor, a humidity sensor, and a carbon dioxide sensor. The one or more sensors may be integrated into a single sensor cluster or may be individual sensors that are collocated. The communications module 630 is configured to make data accessible to any automation or data collection systems that may be connected to the apparatus 200. Communication module 630 may provide communications and information compatible with or using the industry standard TCP/IP network protocol. Peripheral device ports 640, 650 may be included to allow peripheral devices to electronically connect to the processor 610. In some embodiments, the peripheral device ports 640, 650 are optional. The communication module 630 and the optional peripheral device ports 640, 650 may be disposed on the cradle 223 along with the processor 610. Also shown is a light sensor 660 in electronic communication with the processor 610. The processor 610 may be configured to receive data from one or more of the sensors in the sensor module 620 and the light sensor 660 and to organize the data into an open-source accessible format. The open-source accessible data may be transmitted through the communication module 630 and/or stored in a local memory (not shown). The data may be transmitted to any device configured to receive the data, including a computer, the Internet cloud, or other suitable processor as would be understood by a person of ordinary skill in the art. On the sensor module 620, the temperature sensor may be configured to sense the temperature of the air moving through the enclosure 101, 201 through the openings, 120, 130, 214, 310. The humidity sensor may be configured to sensor the humidity of the air moving through the enclosure 101, 201 through the openings, 120, 130, 214, 310. The carbon dioxide sensor may be configured to sense the carbon dioxide levels of the air moving through the enclosure 101, 201 through the openings, 120, 130, 214, 310. The light sensor 660 may be positioned within the enclosure 201 on the angled roof 111, 211 or in view of the opening 113, 213 to allow the light sensor 660 to sense the most accurate lighting levels that are present outside of the enclosure 101, 201. A series of wires 670 may be configured to deliver power to the fans (not shown). Information from the light sensor 660 may be used to provide a record of light levels and/or to provide feedback for control of the illumination outside of the enclosure 201. Illumination levels may be changed by controlling a light source. Suitable light sources can include light bulbs, LEDs, and windows with controllable blinds or tints.

The sensors 620, 660 all use the open-source accessible communications. The sensors 620, 660 may use the same or a different communications language as long as they remain open-source accessible. All of the sensor data may provide real-time data and be used for automation and data logging/reporting.

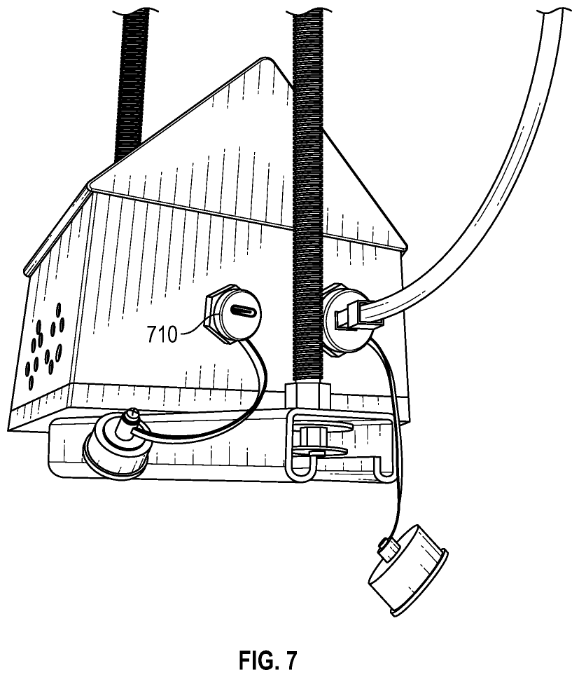

FIG. 7 shows the apparatus 100, 200 with communications connectors 710 mounted at the ports (openings) 140, 320.

In general, the first apparatus 100 (see FIG. 1) and the second apparatus 200 (e.g., FIGS. 2-7 are structurally similar and operationally the same; however, they differ in the manner in which the enclosure 101 and the enclosure 201 are manufactured. Notably, in the first apparatus 100 the lower walls 114 are part of the bottom portion 112, which swings on the hinge 150 connected to the top portion 110, whereas the walls 212 are part of the top portion 210 in the apparatus 200, which includes a removable bottom portion 220.

As shown, the enclosures 101, 201 may be embodied as a custom-designed and (for example) 3D printed housing to match the style of a traditional birdhouse that will be installed in the growing environment amongst the plants. The design has custom mounting locations for the sensors 620660 and the processor 610 to allow for a secure permanent fit.

The processor 610 may be embodied as a non-proprietary processor to process the sensor data for temperature, carbon dioxide, lighting, and relative humidity received from the respective sensors 620, 660.

The suite of sensors 620, 660 works as a complete environmental sensor product. The apparatus 100, 200 may include all the sensors 620, 660, fans 420, processor 610, and communication module 630 installed and pre-programmed and tested. The user simply needs to hang it in the environment to be sensed and plug it into the automation and/or data collection network. The apparatus 100, 200 may be configured to use an embedded webpage that allows for viewing of data on any internet device such as a smartphone, tablet, or computer. All set up for the user is simple and teachable. When the apparatus 100, 200 is to be integrated into an automation system, it behaves consistently with any other sensor being added to a control network.

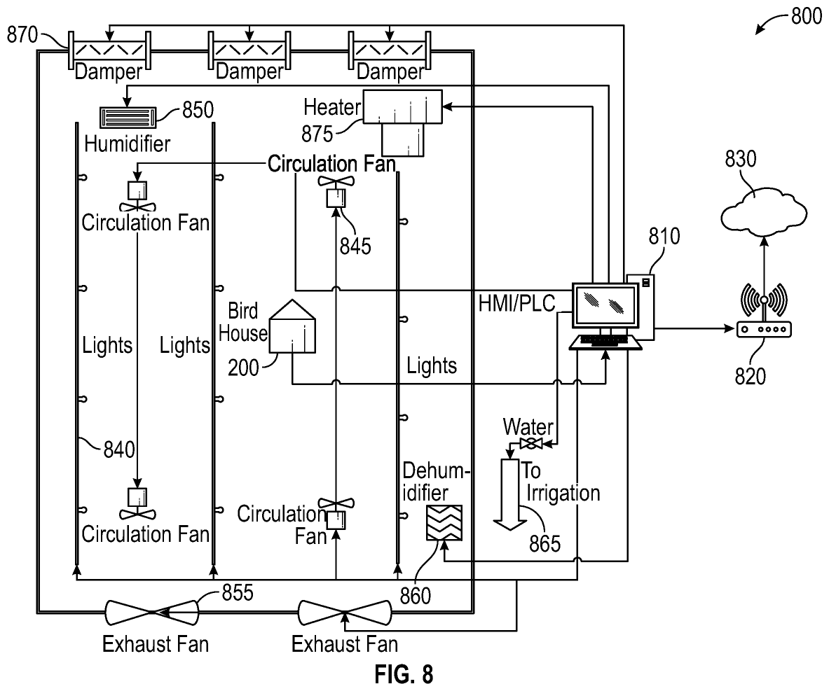

FIG. 8 shows a diagram of system 800 which uses the apparatus 200 as a data collection device. The system 800 may include a computer 810 configured to receive data from the apparatus 200. The computer 810 may store information locally and/or send it to a transmitter 820 for storage and/or access via the Internet cloud 830. The computer 810 may use the data from the apparatus 200 to manage environmental regulation subsystems of the system 800, including, but not limited to, lights 840, circulation fans 845, humidifiers 850, exhaust fans 855, dehumidifiers 860, irrigation 865, dampers 870, and heaters 875.

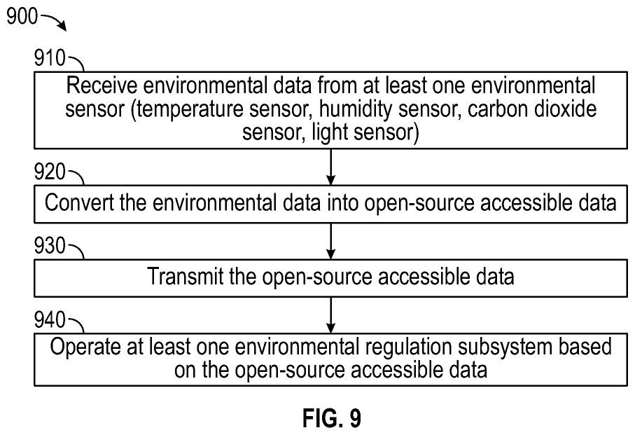

FIG. 9 shows a method 900 of using the system 800. In step 910, environmental data is received by at least one of the sensors in the sensor module 620 or the light sensor 660. In step 920, the environmental data is converted into open-source accessible data by the processor 610. In step 930, the open-source accessible data is transmitted by the communications module 630. In step 940, at least one environmental regulation subsystem may be operated based on the open-source accessible data. In some embodiments, the open-source accessible data will include temperature, humidity, and carbon dioxide information and a vapor pressure deficit may be calculated and used for operating the at least one environmental regulation subsystem 840-875.

As those with skill in the art will appreciate, while some embodiments of the present disclosure may be shown in the form of a birdhouse for aesthetics, it may be embodied in various appropriate shapes. Further, any appropriate processing unit may be used as well as different sensors than the ones specifically mentioned to gather environmental data. The web interface may also take various forms.

In an exemplary embodiment, the present invention may be used as follows. The first and most simple use of the present invention is simply to hang it in the environment, plug in an ethernet cable that goes back to a POE-enabled network router, and then the user can monitor all the sensor data on their phone, tablet, or computer. Of course, those with skill in the art will appreciate that, rather than a wired connection, wireless communication of the data values may also be employed. The current design requires an ethernet connection to transmit the data to an automation system because wireless data is not as secure as hardwired data. However, utilizing a wireless connection is certainly envisioned as a possibility.

Taking this a step further, a user can also integrate the present invention into an automation system. This would involve utilizing the automation person/company programmer to add the present invention to their existing or new automation network. They would add the present invention as a network device to their network. They could then capture the sensor data from the present invention for use within their automation program to control all of the environment devices.

The present invention can be used in any environment, not just in the horticulture industry. An example is that it could be used in any industrial or medical environment to aid in environmental alarming due to increased carbon dioxide levels by automatically controlling an exhaust fan or bringing in fresh air to the environment. This could also apply to monitoring lighting, temperature, and humidity for automatic control in large-scale building environments or correctional facilities. Other such uses are within the spirit and scope of the present disclosure.

In an exemplary embodiment, the present invention may be made and assembled as described above and as follows. If someone were to make the present invention on their own, they would first need to custom design and 3D print the enclosure. They would need to find non-proprietary and accurate sensors that can provide the data in the correct format. They would need to find and program the processor to read the sensor data and make it available using the automation industry-standard communication protocol. They would need to design the user interface and any formatting for automation and/or data reporting.

All elements in the present invention are necessary for this product's design and functionality. The sensor module 620, when including the temperature sensor, the humidity sensor, and the carbon dioxide sensor, may provide real-time data that may be used to determine whether a VPD (Vapor Pressure Deficit) is present in the environment. VPD is a critical value for plant growth optimization. Based on the VPD determination, the system 800 may be activate or deactivate one or more of the environmental regulation subsystems 840-875 to eliminate the VPD condition.

Receiving environmental data using at least one of the temperature sensor, the humidity sensor, the carbon dioxide sensor, and the light sensor. Converting the environmental data into an open-source readable format; transmitting the open-source readable data to an external system.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the preceding describes a number of separate embodiments of the apparatus and method of the present invention, what has been described herein is merely illustrative of applying the principles of the present invention. Other arrangements, methods, modifications, and substitutions by one of ordinary skill in the art are therefore also considered within the scope of the present invention, which is not to be limited except by the claims directed to the present invention.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

While the disclosure has been described with reference to exemplary embodiments, it will be understood that various changes may be made, and equivalents may be substituted for elements thereof, without departing from the scope of the disclosure. In addition, many modifications will be appreciated to adapt a particular instrument, situation, or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

What is claimed is:

1. An apparatus for providing/reporting environmental data, comprising:
an enclosure comprising:
a roof;
a plurality of walls connected to the roof, wherein the plurality of walls comprises at least:
a first wall with a first plurality of openings;
a second wall with a second plurality of openings; and
a third wall disposed opposite the first wall with a third plurality of openings; and
a fourth wall disposed opposite the second wall;
where the first plurality of openings is disposed opposite the third plurality of openings to form an air flow path through the interior of the enclosure; and
a base connected to the plurality of walls;
a processor disposed on the base inside the enclosure;
a communications module disposed on the base inside of the enclosure and in electrical communication with the processor;
a sensor module disposed inside the enclosure and in electrical communication with the processor and comprising:
a temperature sensor;
a humidity sensor; and
a carbon dioxide sensor;
wherein the processor is configured to organize data received from the temperature sensor, the humidity sensor, and the carbon dioxide sensor in an open-source accessible format and transmit the data to the communications module; and where the temperature sensor, the humidity sensor, and the carbon dioxide sensor are positioned proximate to the air flow path.

2. The apparatus of claim 1, where the roof includes an opening configured to allow light to enter the enclosure, and further comprising:
a light sensor positioned proximate to the opening in the roof and in electrical communication with the processor; wherein the processor is configured to organize data from the light sensor in the open-source accessible format.

3. The apparatus of claim 1, further comprising:
one or more fans disposed in enclosure and adjacent to at least one of the openings in the first wall.

4. The apparatus of claim 1, further comprising:
at least one filter covering the openings in the first wall and at least one filter covering the openings in the third wall.

5. The apparatus of claim 1, further comprising:
a plurality of communications connectors disposed in the second plurality of openings.

6. The apparatus of claim 5, wherein the enclosure is isolated from air in the ambient environment except for the first plurality of openings and the third plurality of openings.

7. A system for regulating environmental conditions, comprising:
a sensor apparatus, comprising:
an enclosure comprising:
a roof with an opening configured to allow light to enter the enclosure;
a plurality of walls connected to the roof, wherein the plurality of walls comprise at least:
a first wall with a first plurality of openings;
a second wall with a second plurality of openings; and
a third wall disposed opposite the first wall with a third plurality of openings; and
a fourth wall disposed opposite the second wall;
where the first plurality of openings is disposed opposite the third plurality of openings to form an air flow path through the interior of the enclosure; and
a base connected to the plurality of walls;
a processor disposed on the base inside the enclosure;
a communications module disposed on the base inside of the enclosure and in electrical communication with the processor;
a sensor module disposed inside the enclosure and in electrical communication with the processor and comprising:
a temperature sensor;
a humidity sensor; and
a carbon dioxide sensor;
wherein the processor is configured to organize data received from the temperature sensor, the humidity sensor, and the carbon dioxide sensor in an open-source accessible format and transmit the data to the communications module; and where the temperature sensor, the humidity sensor, and the carbon dioxide sensor are positioned proximate to the air flow path;
a computer in data communication with the communications module and configured to receive the data from the temperature sensor, the humidity sensor, and the carbon dioxide sensor in the open-source accessible format; and
at least one environmental regulation subsystem in data communication with the computer and configured to respond to a computer instruction to modify an environmental parameter based on the received data.

8. The system of claim 7, wherein the at least one environmental regulation subsystem comprises one or more of: a damper, a heater, a humidifier, a dehumidifier, a circulation fan, an exhaust fan, and an irrigation source.

9. The system of claim 7, further comprising a transmitter, where the computer is in electrical communication with the transmitter.

10. The system of claim 7, wherein the roof includes an opening configured to allow light to enter the enclosure, and further comprising:
a light sensor positioned proximate to the opening in the roof and in electrical communication with the processor; wherein the processor is configured to organize data from the light sensor in the open-source accessible format.

11. The system of claim 10, wherein the at least one environmental regulation subsystem comprises a light source that can be controlled based on the data from the light sensor.

12. The system of claim 7, further comprising:
one or more fans disposed in enclosure and adjacent to at least one of the openings in the first wall.

13. The system of claim 7, further comprising:
at least one filter covering the openings in the first wall and at least one filter covering the openings in the third wall.

14. The method of operating an environmental system, comprising:
receiving environmental data from at least one sensor, where the at least one sensor is selected from: a temperature sensor, a humidity sensor, a carbon dioxide sensor, and a light sensor;
converting the environmental data into open-source accessible data; and
transmitting the open-source accessible data.

15. The method of claim 14, further comprising:
operating at least one environmental regulatory system based on the open-source accessible data, wherein the at least one environmental regulatory system is one of a damper, a heater, a humidifier, a dehumidifier, a circulation fan, an exhaust fan, and an irrigation source.

16. The method of claim 14, wherein the at least one sensor comprises: the temperature sensor, the humidity sensor, and the carbon dioxide sensor; and further comprising:
calculating a vapor pressure deficit using the open-source accessible data.
